(19) United States
(12) Patent Application Publication
(10) Pub. No.: US 2014/0215021 A1
(43) Pub. Date: Jul. 31, 2014

(54) VIDEO SERVER AND METHOD FOR INGESTING VIDEO FILE

(71) Applicant: KABUSHIKI KAISHA TOSHIBA, Tokyo (JP)

(72) Inventor: Hiroki Nagai, Hino-shi (JP)

(73) Assignee: KABUSHIKI KAISHA TOSHIBA, Tokyo (JP)

(21) Appl. No.: 13/949,611

(22) Filed: Jul. 24, 2013

(30) Foreign Application Priority Data
Jan. 30, 2013 (JP) 2013-015689

(51) Int. Cl. H04L 29/08

(52) U.S. Cl. CPC H04L 67/06
USPC 709/219

(57) ABSTRACT

According to one embodiment, a video server includes ingesting devices, storage systems, and a controller. The ingesting devices ingest a plurality of video files received from outside. The storage systems store a video file ingested by the ingesting device as broadcast data. The controller selects a storage system between which and the ingesting device a session is to be established from the storage systems on the basis of the total number of sessions established between the ingesting devices and the storage systems when the broadcast data is stored in the storage systems.

### CROSS-REFERENCE TO RELATED APPLICATIONS

This application is based upon and claims the benefit of priority from Japanese Patent Application No. 2013-015689, filed Jan. 30, 2013, the entire contents of which are incorporated herein by reference.

### FIELD

Embodiments described herein relate generally to a video server and a method for ingesting a video file.

BACKGROUND

A video server stores content formed of video data, such as programs and commercials, used in broadcast stations, in a storage system including a flash memory, for example, as a video file in a file format such as a Material eXchange Format (MXF) file. The video server transmits an MXF file being stored therein according to a request from an automatic program production control device. In a system that uses this type of video server, an MXF file stored in a file server is transferred from the file server to the video server, using the general-purpose File Transfer Protocol (FTP).

When a video server includes a plurality of storage systems and a plurality of ingestings are requested, a main controller of the video server determines which of the storage systems an MXF file is to be ingested at the start of ingesting, such that a plurality of ingestings are equally distributed among the storage systems, for improvement in the speed of ingesting. The main controller places a limit on the number of simultaneous ingestings that are allocated to one storage system, such that the ingesting speed does not fall below the video bitrate of the content.

The main controller allocates the same amount of resources to each of the ingestings, regardless of the ingesting speed of an MXF file supplied from the file server. This can lead to a situation where the maximum ingesting bandwidth of the storage system cannot be reached, even when the number of simultaneous ingestings reaches the limit.

### BRIEF DESCRIPTION OF THE DRAWINGS

FIG. 1 shows an exemplary configuration of a video processing system comprising a video server according to an embodiment;

FIG. 2 is a block diagram illustrating a functional configuration of the video server shown in FIG. 1;

FIG. 3 is a block diagram illustrating a functional configuration of a main controller shown in FIG. 1;

FIG. 4 is an exemplary diagram illustrating a construction management information table stored in a memory shown in FIG. 3;

FIG. 5 is an exemplary diagram illustrating a resource management information table stored in the memory shown in FIG. 3;

FIGS. 6A and 6B are exemplary diagrams illustrating a content management information table stored in the memory shown in FIG. 3;

FIG. 7 is a flowchart illustrating a procedure of the main controller when the video server shown in FIG. 1 switches ingesting destinations of a video file;

FIG. 8 is an exemplary diagram illustrating an initial state of the flowchart shown in FIG. 7;

FIG. 9 is an exemplary diagram of a state after the flowchart shown in FIG. 7 is applied to the state shown in FIG. 8; and

FIG. 10 is an exemplary diagram of a state after the flowchart shown in FIG. 7 is applied to the state shown in FIG. 9.

### DETAILED DESCRIPTION

In general, according to one embodiment, a video server includes ingesting devices, storage systems, and a controller. The ingesting devices ingest a plurality of video files received from outside. The storage systems store a video file ingested by the ingesting device as broadcast data. The controller selects a storage system between which and the ingesting device a session is to be established from the storage systems on the basis of the total number of sessions established between the ingesting devices and the storage systems when the broadcast data is stored in the storage systems.

### First Embodiment

Hereinafter, an embodiment will be described with reference to the accompanying drawings.

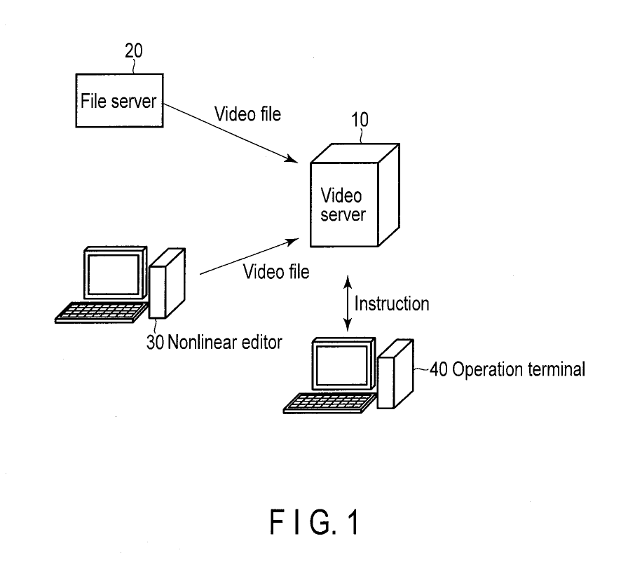

FIG. 1 is a schematic diagram illustrating an exemplary configuration of a video processing system comprising a video server 10 according to the embodiment. The video processing system shown in FIG. 1 has the video server 10, a file server 20, a nonlinear editor 30, and an operation terminal 40. The video server 10 is connected to the file server 20, the nonlinear editor 30, and the operation terminal 40 via an intra-system network, for example.

The file server 20 stores content formed of video data, such as TV programs and TV commercials, as video files in a file format in advance. Examples of such a file format include Material eXchange Format (MXF). The file server 20 outputs a stored video file to the video server 10, according to an instruction from a host device, for example.

The nonlinear editor 30 reads the video file stored in the video server 10 according to a request from the user. The user edits the read video file using the nonlinear editor 30. The nonlinear editor 30 outputs the edited video file to the video server 10.

The operation terminal 40 accepts a ingesting command from the user and outputs the accepted ingesting command to the video server 10.

The video file ingested in the video server 10 is read in accordance with a playback command input from the operation terminal 40, and is output as a video signal. The output video signal is displayed on a video monitor and/or distributed by broadcasting equipment.

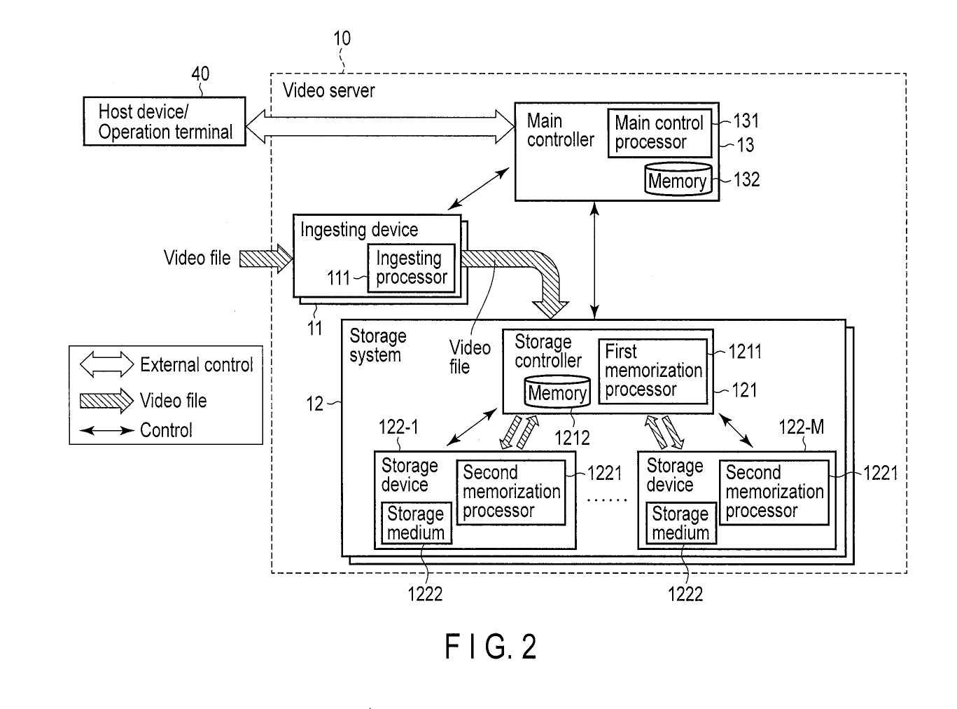

FIG. 2 is a block diagram illustrating a functional configuration of the video server 10 according to the embodiment. The video server 10 shown in FIG. 2 has a ingesting device 11, a storage system 12, and a main controller 13. In the video server 10 shown in FIG. 2, a plurality of ingesting devices 11 and a plurality of storage systems 12 are provided. The ingesting device 11, the storage system 12, and the main controller 13 are connected via a bus or a network, for example.

The ingesting device 11 has a central processing unit (CPU), for example, and a read-only memory (ROM) and a random-access memory (RAM), for example, including a storage region for programs and data for the CPU to perform operations. The ingesting device 11 includes a ingesting processor 111, which causes the CPU to perform programs.

The ingesting processor 111 receives a video file supplied from outside. The maximum communication speed of a network connecting the ingesting device 11 and the storage system 12 is set in advance so as not to fall below the video bitrate of the video file. In this case, the video file supplied from outside may be one video file supplied at a communication speed close to the maximum communication speed, or a plurality of video files that are supplied such that the total communication speed becomes close to the maximum communication speed. Upon receipt of an instruction for a request for ingesting a video file and an instruction for specifying one of the storage systems 12 as a ingesting destination from the main controller 13, the ingesting processor 111 outputs the video file supplied from outside to the specified storage system 12.

Further, the ingesting processor 111 receives an instruction for a request for moving a ingesting destination of a video file, and an instruction for specifying a video file to be moved and a storage system 12 to which the video file is to be moved from the main controller 13. Upon receipt of an instruction for a moving request and an instruction for specifying a video file to be moved and a storage system 12 to which the video file is to be moved when at least some of the video files supplied from outside are output to storage systems 12 that are different from each other, the ingesting processor 111 outputs the specified video file to the specified storage system 12.

The storage system 12 has a storage controller 121 and storage devices 122-1 to 122-M. The maximum ingesting bandwidth of the storage system 12 is set in advance.

The storage controller 121 has a CPU, for example, and a ROM and a RAM, for example, including a storage region for programs and data for the CPU to perform operations, and includes a first memorization processor 1211, which causes the CPU to perform programs, and a memory 1212.

Upon receipt of a request for ingesting a video file from the main controller 13, the first memorization processor 1211 causes storage devices 122-1 to 122-M to store the video file output from the ingesting device 11 using a redundancy system called redundant array of independent disks (RAID), for example. Upon completion of the ingesting process of the video file, the first memorization processor 1211 outputs a completion notification to the main controller 13.

Each of storage devices 122-1 to 122-M has a CPU, for example, and a ROM and a RAM, for example, including a storage region, for example, for programs and data for the CPU to perform operations, and includes a second memorization processor 1221 which causes the CPU to perform programs. Each of storage devices 122-1 to 122-M includes a storage medium 1222 formed of a flash memory, for example. The second memorization processor 1221 stores data supplied from the storage controller 121 in the storage medium 1222.

The main controller 13 has a CPU, for example, and a ROM and a RAM, for example, including a storage region, for example, for programs and data for the CPU to perform operations. The main controller 13 includes a main control processor 131, which causes the CPU to perform programs, and a memory 132, and controls a ingesting process in the video server 10.

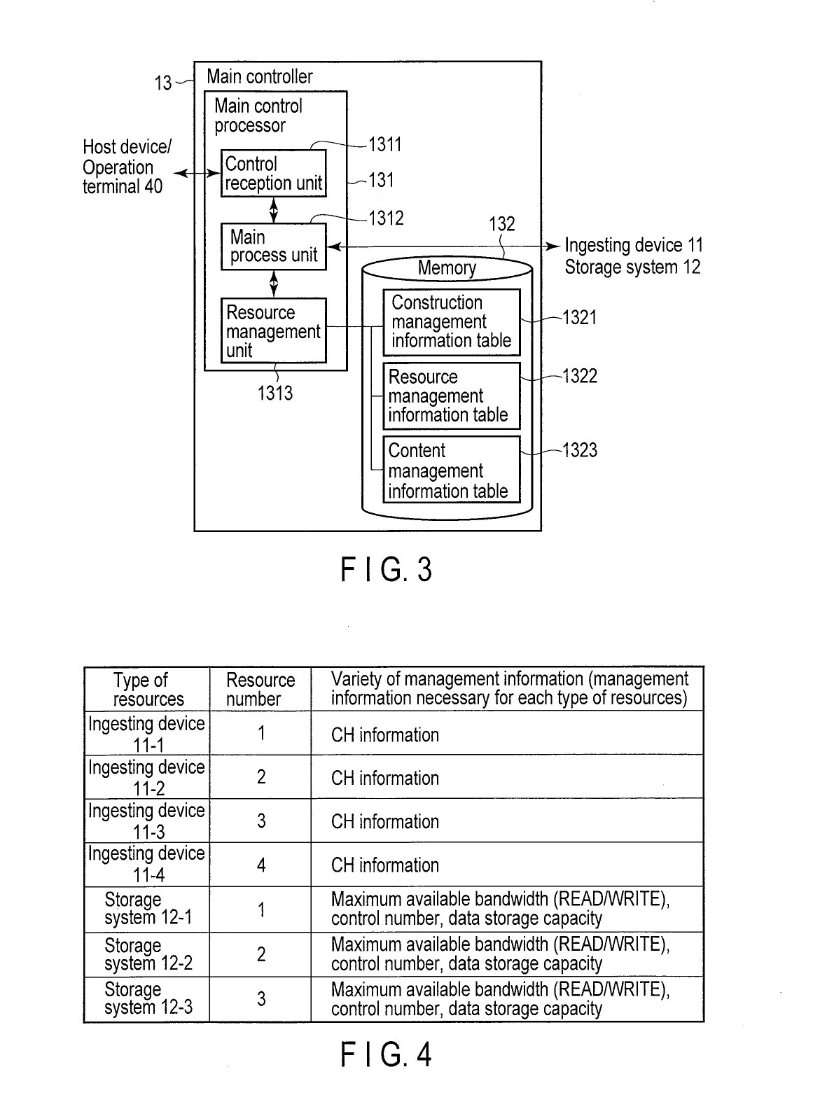

FIG. 3 is a block diagram illustrating a functional configuration of the main control processor 131 and information stored in the memory 132, according to the embodiment. The main control processor 131 shown in FIG. 3 has a control reception unit 1311, a main process unit 1312, and a resource management unit 1313. The memory 132 shown in FIG. 3 includes a construction management information table 1321, a resource management information table 1322, and a content management information table 1323.

FIG. 4 is an exemplary diagram illustrating the construction management information table 1321 stored in the memory 132. In FIG. 4, management information necessary for each type of resources is schematically shown, for the sake of simplicity. In the construction management information table 1321 shown in FIG. 4, information necessary for a ingesting process, for example, is managed for each constitutional device. The construction management information table 1321 shown in FIG. 4 represents a table when the video server 10 includes ingesting devices 11-1 to 11-4 and storage systems 12-1 to 12-3.

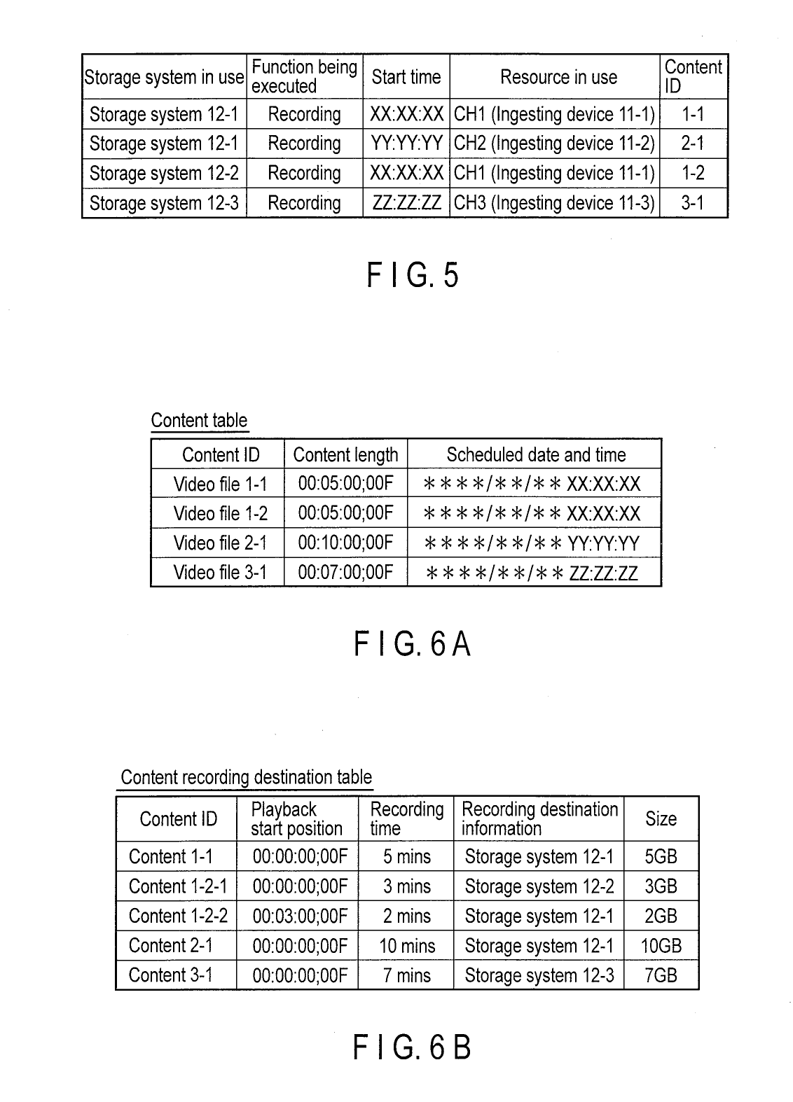

FIG. 5 is an exemplary diagram of the resource management information table 1322 stored in the memory 132. In the resource management information table 1322 shown in FIG. 5, a process currently being executed and a start time of the process being executed, for example, are managed for each storage system. FIG. 5 is an exemplary diagram illustrating a case where four sessions are established in parallel between storage systems 12-1 to 12-3 and ingesting devices 11-1 to 11-3, by way of example. According to FIG. 5, video files assigned with content IDs 1-1 and 1-2 are ingested in storage systems 12-1 and 12-2, respectively. A video file assigned with content ID 2-1 is ingested in storage system 12-1. A video file assigned with content ID 3-1 is ingested in storage system 12-3.

The maximum number of sessions that can be simultaneously established is set in the main control processor 131 in advance. The main control processor 131 manages ingestings that can be simultaneously performed on the basis of the set maximum number. The main control processor 131 calculates a remaining bandwidth obtained by subtracting a bandwidth used in the ingesting process currently being executed from the maximum ingesting bandwidth of the storage system 12.

FIG. 6 is an exemplary diagram illustrating the content management information table 1323 stored in the memory 132. The content management information table 1323 includes a content table shown in FIG. 6A and a content ingesting destination table shown in FIG. 6B. The content table manages information on the entire content, such as content length indicating the ingesting time of a video file, and scheduled date and time when the video file is to be broadcast. The content ingesting destination table manages information such as a ingesting destination of each management unit of the content. The content ingesting destination table shown in FIG. 6B represents a case where video file 1-2 is stored across storage systems 12-1 and 12-2, by way of example.

The control reception unit 1311 receives a ingesting command input from the operation terminal 40 or a host device (not shown). The control reception unit 1311 outputs the received ingesting command to the main process unit 1312.

Upon receipt of a response message from the main process unit 1312, the control reception unit 1311 outputs the received response message to the operation terminal 40 or the host device.

Upon receipt of a ingesting command supplied from the control reception unit 1311, the main process unit 1312 makes a request to the resource management unit 1313 for resources that are available for a ingesting process.

Upon receipt of information on a ingesting device 11 and a storage system 12 that are available for a ingesting process from the resource management unit 1313, the main process unit 1312 outputs a ingesting request to the available ingesting device 11 and causes the ingesting device 11 to specify the available storage system 12 as a ingesting destination. Further, the main process unit 1312 outputs a ingesting request to the available storage system 12.

Upon receipt of a completion notification from the storage system 12 indicating that ingesting of a video file has been completed, the main process unit 1312 causes the resource management unit 1313 to update the content management information table 1323. Upon completion of update of the content management information table 1323, the main process unit 1312 generates a response message indicating completion of the process, and outputs the generated response message to the control reception unit 1311.

Upon receipt of a moving request from the resource management unit 1313, the main process unit 1312 causes at least some of a plurality of sessions established with storage systems 12 that are different from each other via a single ingesting device 11 to be established with the same storage system 12. In this case, the main process unit 1312 specifies a video file to be moved and a storage system 12 to which the video file is to be moved, and outputs a ingesting request to the ingesting device 11 via which a plurality of sessions are established. The main process unit 1312 outputs a ingesting request to the storage system 12 to which the video file is to be moved to ingest the video file to be moved. Upon completion of the moving process, the main process unit 1312 causes the resource management unit 1313 to update the resource management information table 1322.

Upon receipt of a resource request made in accordance with the ingesting request from the main process unit 1312, the resource management unit 1313 acquires an available ingesting device 11 and an available storage system 12 by referring to the construction management information table 1321, the resource management information table 1322, and the content management information table 1323 stored in the memory 132. The resource management unit 1313 outputs information on the acquired ingesting device 11 and the storage system 12 to the main process unit 1312.

More specifically, upon receipt of a resource request, the resource management unit 1313 determines whether the number of sessions to be ingested in parallel exceeds the maximum number of sessions set in advance or not, by referring to the construction management information table 1321, the resource management information table 1322, and the content management information table 1323. When the number of sessions to be ingested in parallel exceeds the maximum number of sessions, the resource management unit 1313 determines whether a plurality of sessions are established via one ingesting device 11 or not. When a plurality of sessions are established via one ingesting device 11, the resource management unit 1313 determines whether at least some of the storage systems 12, which are destinations of a plurality of sessions established via a single ingesting device 11, are different or not. When destinations of a plurality of sessions are storage systems 12 that are different from each other, the resource management unit 1313 outputs a moving request to the main process unit 1312 to move a destination of one of the sessions to the same destination as a destination of another session. In this case, the resource management unit 1313 specifies a ingesting device 11 which is to be a target for a moving process, a video file to be moved, and a storage system 12 to which the video file is to be moved. Upon completion of the moving process of the video file and update of the resource management information table 1322, the resource management unit 1313 acquires an available ingesting device 11 and an available storage system 12 by referring to the construction management information table 1321, the resource management information table 1322, and the content management information table 1323, and outputs information on the acquired ingesting device 11 and the storage system 12 to the main process unit 1312.

A detailed description will now be given on the process in which the video server 10 with the above-described configuration switches ingesting destinations of a video file. In the description that follows, a case will be described where the video server 10 has ingesting devices 11-1 to 11-9 with the maximum communication speed of 1 Gbps and storage systems 12-1 to 12-3 with the maximum ingesting bandwidth of 3 Gbps, by way of example. In this case, in the resource management unit 1313 of the main controller 13, the maximum number of sessions that can be established in each of storage systems 12-1 to 12-3 is set to 3, which means 9 in total.

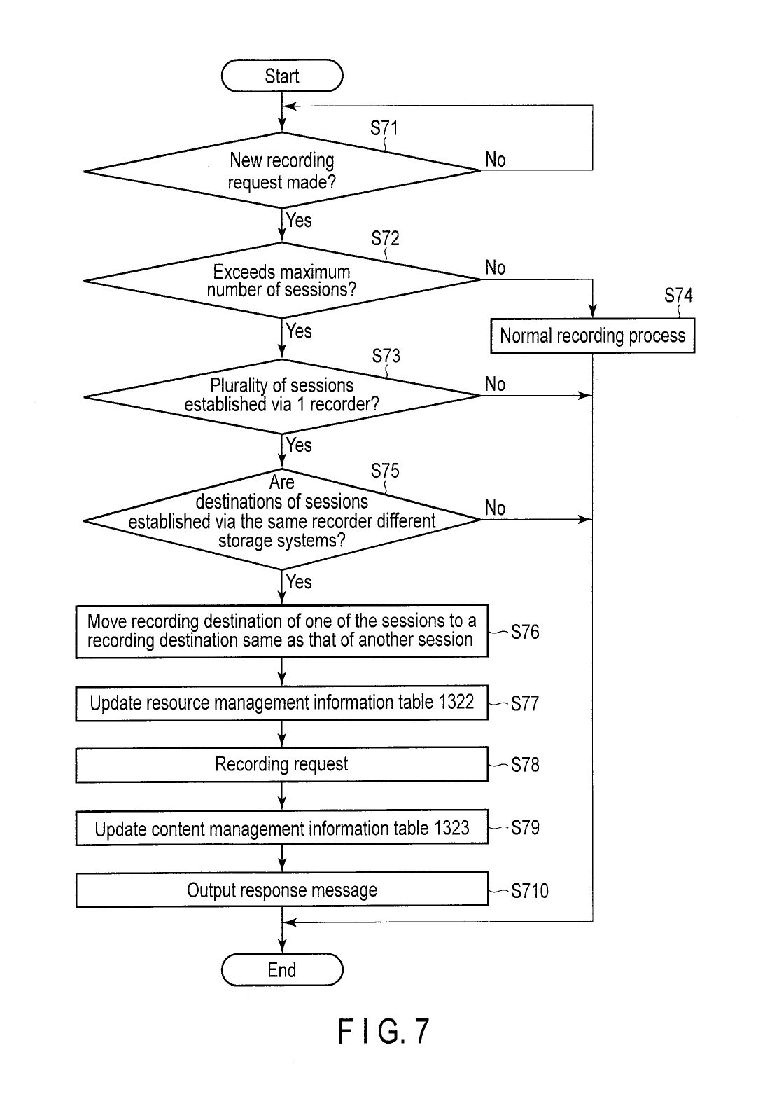

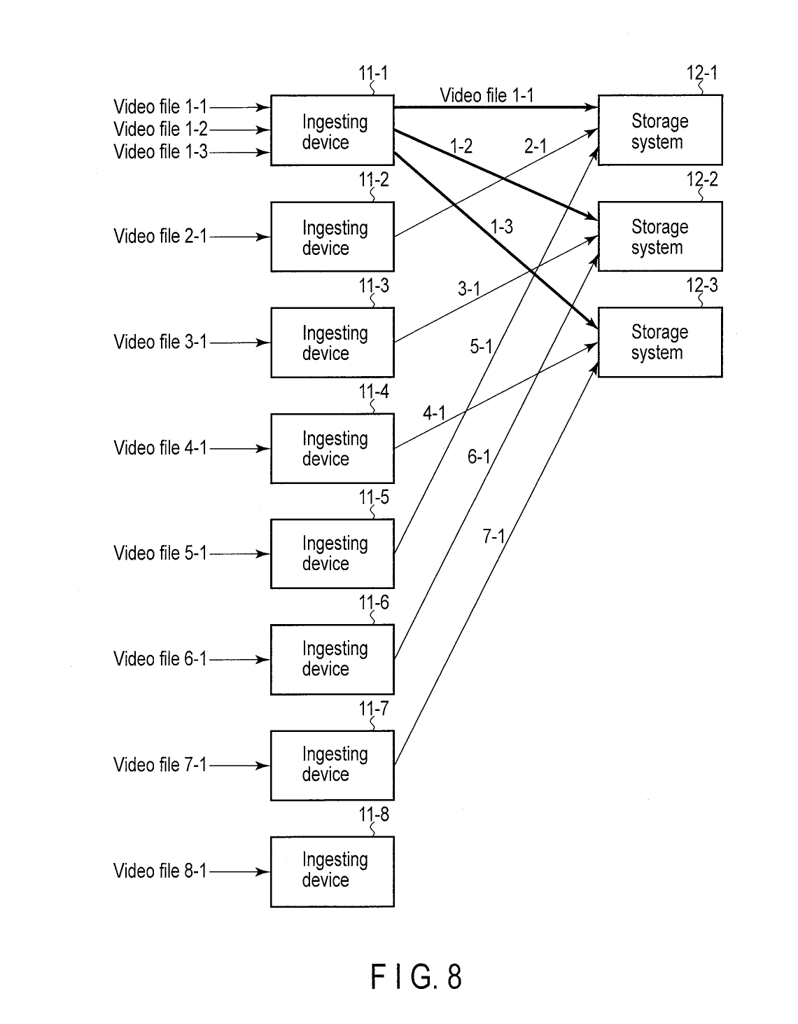

FIG. 7 is a flowchart illustrating a procedure of the main controller 13 when the video server 10 according to the embodiment switches ingesting destinations of a video file. FIG. 8 is an exemplary schematic diagram illustrating an initial state of the flowchart shown in FIG. 7. In FIG. 8, three sessions are established via ingesting device 11-1. Since the maximum communication speed of ingesting device 11-1 is 1 Gbps, the total communication speed of the three sessions does not exceed 1 Gbps. For example, video files are supplied at the communication speed of 333 Mbps per session. In each of ingesting devices 11-2 to 11-7, one session is established, and video files are supplied at the maximum communication speed of 1 Gbps or less. Ingesting device 11-1 outputs video files 1-1 to 1-3 at the communication speed of 333 Mbps to storage systems 12-1 to 12-3, respectively. Ingesting device 11-2 outputs a video file 2-1 to storage system 12-1 at the communication speed of 1 Gbps. Ingesting device 11-3 outputs a video file 3-1 to storage system 12-2 at the communication speed of 1 Gbps. Ingesting device 11-4 outputs a video file 4-1 to storage system 12-3 at the communication speed of 1 Gbps. Ingesting device 11-5 outputs a video file 5-1 to storage system 12-1 at the communication speed of 1 Gbps. Ingesting device 11-6 outputs a video file 6-1 to storage system 12-2 at the communication speed of 1 Gbps. Ingesting device 11-7 outputs a video file 7-1 to storage system 12-3 at the communication speed of 1 Gbps.

The main process unit 1312 determines whether a new ingesting request has been made (step S71). In FIG. 8, when a ingesting request for a video file 8-1 has been made (Yes in step S71), the main process unit 1312 outputs a resource request to the resource management unit 1313. When a new ingesting request has not been made (No in step S71), the main process unit 1312 repeats step S71 until a new ingesting request is received.

Upon receipt of a resource request, the resource management unit 1313 determines whether the number of sessions exceeds the maximum number of sessions when ingesting of video file 8-1 is performed, by referring to the resource management information table 1322 (step S72). In FIG. 8, since the number of sessions becomes 10 when ingesting of video file 8-1 is performed, the number of sessions exceeds 9, which is the maximum number of sessions (Yes in step S72). In this case, the resource management unit 1313 determines whether a plurality of sessions are established via one ingesting device 11 (step S73). When the number of sessions does not exceed 9, which is the maximum number of sessions, even when ingesting of video file 8-1 is performed (No in step S72), the main process unit 1312 outputs a ingesting request to ingesting device 11-8 and the storage system 12 to ingest video file 8-1 from ingesting device 11-8 to one of the storage systems 12 (step S74).

Since ingesting device 11-1 outputs video files 1-1 to 1-3 in step S73 (Yes in step S73), the resource management unit 1313 determines whether at least some of video files 1-1 to 1-3 are output to different storage systems (step S75). Since video files 1-1 to 1-3 are ingested in storage systems 12-1 to 12-3, respectively (Yes in step S75), the resource management unit 1313 outputs a moving request for specifying ingesting device 11-1 to the main process unit 1312, so as to move the ingesting destination of video file 1-2, which is being ingested in storage system 12-2, to storage system 12-1. Upon receipt of the moving request, the main process unit 1312 outputs a ingesting request to ingesting device 11-1 to output video file 1-2 to storage system 12-1. The main process unit 1312 outputs a ingesting request to storage system 12-1 to store video file 1-2 (step S76). After moving the ingesting destination of video file 1-2 to storage system 12-1, the main process unit 1312 causes the resource management unit 1313 to update the resource management information table 1322 (step S77).

The resource management unit 1313 outputs information on ingesting device 11-8 and storage system 12-2, which are available for use for a ingesting process of video file 8-1, to the main process unit 1312, by referring to the construction management information table 1321, the resource management information table 1322, and the content management information table 1323. The main process unit 1312 outputs a ingesting request to ingesting device 11-8 and storage system 12-2 to ingest video file 8-1 (step S78). Upon completion of the ingesting process, the main process unit 1312 causes the resource management unit 1313 to update the content management information table 1323 (step S79). The resource management unit 1313 generates a response message, and outputs the generated response message to the operation terminal 40 (step S710).

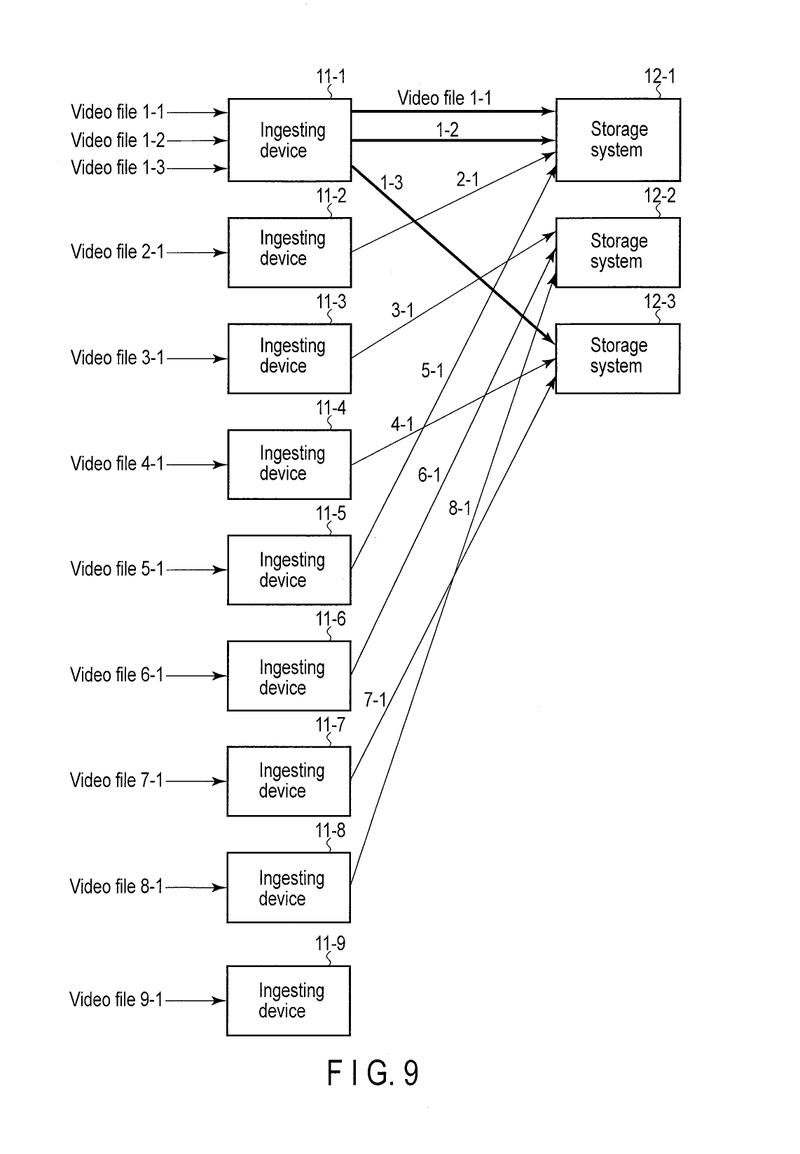

FIG. 9 is a schematic diagram illustrating a ingesting situation in which the ingesting destination of video file 1-2 is moved to storage system 12-1, and video file 8-1 is ingested in storage system 12-2 through steps S71-S710.

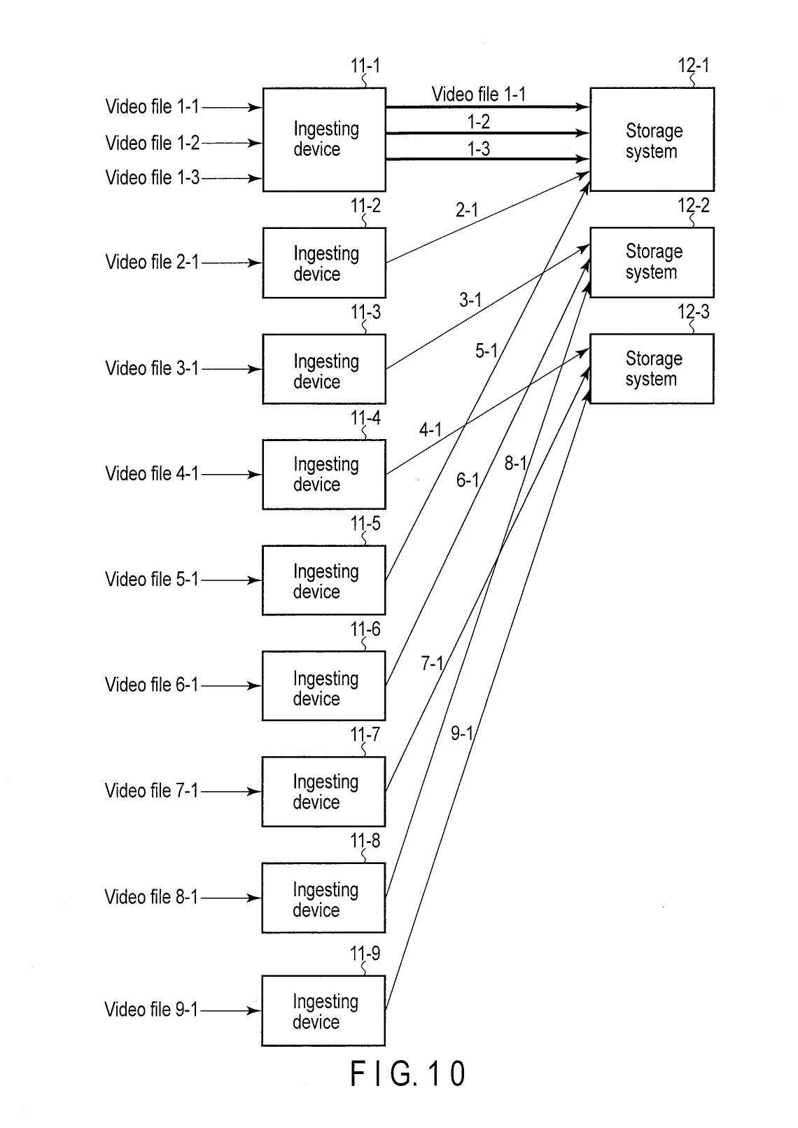

When the state shown in FIG. 9 is set as the initial state of the flowchart shown in FIG. 7 and ingesting of video file 9-1 is requested, the main controller 13 moves the ingesting destination of video file 1-3 from storage system 12-3 to storage system 12-1 by performing steps S71 to S710 shown in FIG. 7. The main controller 13 causes ingesting device 11-9 to ingest the requested video file 9-1 in storage system 12-3, thereby achieving the state shown in FIG. 10.

In FIGS. 7-10, a case has been described where the main controller 13 moves video files to be ingested in storage systems 12-2 and 12-3 from ingesting device 11-1 to storage system 12-1 one by one, whenever ingesting of a video file is newly requested, by way of example. However, the present embodiment is not limited thereto. For example, upon receipt of a request for ingesting video file 8-1, the main controller 13 may move the ingesting destination of video files 1-2 and 1-3 to storage system 12-1.

As described above, according to the above-described embodiment, when ingesting of a video file is newly requested, the main controller 13 ingests at least two video files ingested from a single ingesting device 11 to a plurality of storage systems 12 in one storage system 12.

An operation of a conventional video server will now be described with reference to FIG. 8. When ingesting of the maximum number of sessions shown in FIG. 8 is performed in parallel, a conventional video server cannot perform a new ingesting process. Since video files 1-2 to 1-3 are supplied at the communication speed of 333 Mbps, and the other video files are supplied at the communication speed of 1 Gbps, a ingesting bandwidth of each of storage systems 12-1 to 12-3 occupied by ingesting of these video files is 2.333 Gbps. This is smaller than 3 Gbps, which is the maximum ingesting bandwidth of each of storage systems 12-1 to 12-3. That is, the maximum ingesting bandwidth of the storage system is not effectively utilized in the conventional video server.

In the video server 10 according to the present embodiment, on the other hand, since the main controller 13 changes resources allocated for ingesting according to the number of sessions established via one ingesting device 11, the maximum ingesting bandwidth of the storage system 12 can be reached. Further, since the main controller 13 can effectively utilize the ingesting bandwidth of the storage system 12, the number of simultaneous file ingestings can be increased.

Therefore, according to the video server of the present embodiment, it is possible to equally distribute a plurality of ingestings among a plurality of storage systems, and to more effectively use the maximum ingesting bandwidth of the storage system.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A video server comprising:
a plurality of ingesting devices configured to ingest a plurality of video files received from outside;
a plurality of storage systems configured to store a video file ingested by the ingesting device as broadcast data; and
a controller configured to select a storage system between which and the ingesting device a session is to be established from the storage systems on the basis of the total number of sessions established between the ingesting devices and the storage systems when the broadcast data is stored in the storage systems.

2. A video server comprising:
a first ingesting device configured to output a plurality of first video files received from outside to a specified ingesting destination;
a second ingesting device configured to output a second video file received from outside to a specified ingesting destination;
a plurality of storage systems configured to store at least one of the first video files output from the first ingesting device and the second video file output from the second ingesting device; and
a controller configured to specify one of the storage systems as a ingesting destination in the first ingesting device upon receipt of a request for ingesting the first video file, specify one of the storage systems as a ingesting destination in the second ingesting device upon receipt of a request for ingesting the second video file, and specify a ingesting destination in the first ingesting device so as to change one of the ingesting destinations of the first video files to a ingesting destination of another first video file when the number of the first and second video files stored in parallel in the plurality of storage systems exceeds a number set in advance upon receipt of a new ingesting request.

3. The video server according to claim 2, wherein the controller includes:
a resource management unit configured to generate a moving request if the number of ingestings ingested in parallel exceeds the number set in advance and at least two of the first video files are stored in storage systems different from each other when the new ingesting request is performed; and
a process unit configured to specify a ingesting destination in the first ingesting device so as to switch a ingesting destination of one of the first video files ingested in the storage systems different from each other to a ingesting destination of another first video file upon receipt of the moving request.

4. A method for ingesting a video file used in a video server comprising: a first ingesting device configured to output a plurality of first video files received from outside to a specified ingesting destination; a second ingesting device configured to output a second video file received from outside to a specified ingesting destination; and a plurality of storage systems configured to store at least one of the first video files output from the first ingesting device and the second video file output from the second ingesting device, the method comprising:
determining, upon receipt of a new ingesting request, whether the number of the first and second video files stored in parallel in the plurality of storage systems has reached a number set in advance; and
specifying a ingesting destination in the first ingesting device so as to change a ingesting destination of one of the first video files to a ingesting destination of another first video file when it is determined that the number of the first and second video files stored in parallel in the storage systems has reached the number set in advance.

5. The method of claim 4, wherein
generating a moving request if the number of ingestings ingested in parallel exceeds the number set in advance and at least two of the first video files are stored in storage systems different from each other when the new ingesting request is performed, and,
specifying a recording destination in the first ingesting device so as to switch a ingesting destination of one of the first video files ingested in the storage systems different from each other to a ingesting destination of another first video file when the moving request is generated.
